(19) United States
(12) Patent Application Publication
(10) Pub. No.: US 2024/0253017 A1
(43) Pub. Date: Aug. 1, 2024

(54) ON THE PRODUCTION OF VISIBLE LIGHT ACTIVE TIO2 NANOSTRUCTURES

(71) Applicant: ISTANBUL SABAHATTIN ZAIM ÜNIVERSITESI, Küçükçekmece, Istanbul (TR)

(72) Inventor: Osman ARSLAN, Istanbul (TR)

(73) Assignee: ISTANBUL SABAHATTIN ZAIM ÜNIVERSITESI, Küçükçekmece, Istanbul (TR)

(21) Appl. No.: 18/565,766

(22) PCT Filed: Mar. 11, 2022
(86) PCT No.: PCT/TR2022/050229

§ 371 Date: Nov. 30, 2023

(30) Foreign Application Priority Data
Aug. 23, 2021 (TR) 2021/013327

(51) Int. Cl. B01J 21/06; B01J 35/39; B01J 35/45; B01J 37/08; C01G 23/053

(52) U.S. Cl. CPC B01J 21/063; B01J 35/39; B01J 35/45; B01J 37/086; C01G 23/053; C01P 2002/54; C01P 2004/64

(57) ABSTRACT

The embodiments relate to visible range active, doped TiO2 nanostructures with the hot injection method in a protected atmosphere showing the enhanced photocatalytic properties in the visible region. It is the production method of TiO2 nanostructures, where obtained nanostructures can be yellow-orange in color, doped with the nitrogen as spectroscopic techniques evidenced. This is the first time observation and detection that hot injection method can be used for the geometry controlled (spherical, elongated or acicular) TiO2 nanostructures starting from a well designed titanium precursors complexed with long chain amine or carboxylic acids.

### TECHNICAL FIELD

This invention describes the visible light active TiO2 nanostructures, in particular, by the reaction of complexes of Titanium salts with long chain carboxylic acids and amines in a protected atmosphere for the production of the yellow-orange products at the temperatures determined by the hot injection method. Obtained nitrogen-doped TiO2 nanostructures show a much more efficient photocatalytic activity and quantum efficiency than standard TiO2 (anatase) structures when quantum efficiencies are compared. In addition to the spherical structures, at the same time, acicular structures can be produced as an alternative where kinetic growth is applied instead of thermodynamic growth.

### BACKGROUND OF THE INVENTION

Titanium dioxide is usually in three crystal forms namely anatase, rutile, and brookite. This material is widely used in optical applications due to its very favorable band gap energy and it is produced industrially, which is used as a white pigment in the paint industry and apart from areas such as the ceramic industry, plastics, and paper industry, it is also frequently used for nanotechnological and self-cleaning surfaces. Its widely known phenomena called photocatalytic activity of the electron-hole pair, which is formed by the effect of UV light, which is almost 3% in daylight, the electron transferred from the valence band to the conduction band in accordance with the band gap energy. This striking effect and electron-hole pair, first discovered by Japanese scientists Honda and Fujishima in the 1970s, actually emerged from studies for the separation of water and hydrogen production. Once this electron-hole pair is created, if they are not used to do a chemical work, for example, if they are not properly transferred to other processes, they can be destroyed in a process called recombination. Thus, the TiO2 semiconductor structure excited by photons becomes a parameter of the redox potentials between the conduction and valence band. If the potential determined by the oxidation potential is more positive than the conduction band of the semiconductor, electron-hole reactions proceed on their own. However, band gap values or optical properties are generally finely controlled for metal oxide structures, by metal doping in TiO2 synthesis, or by nonmetal doping and last by other structures that show electron or hole carrier properties. TiO2 structures were recently used in self-cleaning and light-activated surface coatings, also in the production of hydrogen which is a source that will enable the water as fuel. Additionally it is a photocatalyst since it transforms organics and sometimes inorganic structures into harmless compounds by a fascinating oxidating mechanism. Interestingly all these processes which is enabled by TiO2 are the systems activated by using UV light. It is known that the band gap energy is generally around 3.2 eV for anatase TiO2 structures. In particular, nanostructure production in TiO2 has come to the peak due to the extraordinary surface/volume values, electrical properties, optical properties and quantum activities of these material. Chlorine process and sulfate process are common in industrial TiO2 synthesis. In the sulfate process, TiO2 is obtained from the ilmenite mixture by the sulfuric acid process. The chlorine process, on the other hand, follows the conversion of titanium-containing sprouts to a chlorine compound by a known method and then the conversion of TiO2 in the gas phase. In general, TiO2 can go through many different washing and purification processes before finalized product is produced.

Currect standarts reveal that among the top down or bottom up methods of TiO2 production, the bottom up method is the most preferred way for its allowance of molecular control and surface modification. Although the industrial process follows the reverse, nano TiO2 is obtained very easily with the bottom up method. However, as a general problem of nanoparticles, side features such as agglomeration and uncontrollability of the surface in industrial processes can cause crystal structure formation and purity, and photocatalytic activity differences. Although the size is not very important in the production of TiO2 in general, the biggest problems for the synthesis of titania in nanotechnological dimensions are that the energy required for the activation of the TiO2 nanocrystal structure is required by the photons of the UV region. Therefore, anatase or rutile needs energy in the UV region for excitation. Therefore, the obtained TiO2 nanocrystals must pass through a revolutionary intermediate process and be in a state that can be activated by electromagnetic rays in the visible region. In addition to solution processes called wet methods in similar ways, methods such as sol-gel technique, PVD or CVD techniques, sputtering are also applied in the production of TiO2.

XRD analysis showed nano-structured particles obtained in the high-grade anatase crystal structure in the present invention. In addition, the most important and distinctive new feature of this method is the adjustable nitrogen doping into the TiO2 structure and the photocatalytic active product can be obtained in the visible region. Nitrogen doping is easily detectable as a color change in nanoparticles, also in EDX, XPS and UV analysis, as well as in physical observations. There is not much change in XRD since doping do not have noticeable effect on XRD pattern. Nanocrystals can be obtained around 30 nm and are very different from standard Degussa P-25 TiO2 with their yellow-orange color. While nanoparticles are active in the UV region in structures obtained by previous techniques, TiO2 nanoparticles obtained with this invention show activity in the visible region. These properties can be confirmed by XPS analyzes as well as the yellow-orange color of the particles obtained. In addition, when the photocatalytic activity tests were performed, it was proven by UV-Vis decomposition measurements that it showed a 75% higher photocatalytic activity than Degussa P 25. Therefore, it is detected that for the first time nitrogen doped TiO2 in the visible region by a hot injection method was discovered. For the first time, TiO2 nanocrystals, which are active in the visible region, were obtained by hot injection method with mentioned chemical precursors.

The hot injection method studies are basically known as the quantum particle production method developed by Bawendi. Generally, many structures such as calcinogen structures such as CdSe, CdS, PbSe can be synthesized. However, the biggest problem of the hot injection method is that the injection method is not suitable for the synthesis of a homogeneous and monodispersed quantum particles due to the temperature change during injection. When the theory of particle formation is examined, the injection process reduces the high temperature of,—lets assume—300-350° C. in the container of the reactants to 200° C. at once. This fluctuations affect the conditions of synthesis of a homogeneous nanoparticle or quantum dot preventing the synthesis of monodispersed large quantities of nanoparticles or quantum particles. However, with this discovery it was tested that another advantage arises allowing the tuning the amount of doping for similar metal oxides. In this way, each injection can be evaluated as an independent process.

In studies carried out with the hot injection method, solvents with high boiling points can be selected with coordinative or non-coordinative properties. Heavy metals are often used for the synthesis of nanoparticles. However, decomposition characteristics and solvent selection are the most important parameters of hot injection reactions. Although the hot injection method for metal oxide synthesis is not used unless it brings very extreme chemical or physical features, this discovery seems to change the old version of this technique. A prominent example is the synthesis of superparamagnetic Fe3O4 nanoparticles, which was obtained in a very homogeneous manner. In addition, trending perovskite nanoparticles can be synthesized in this way.

This invention provides a molecular approach to TiO2 particle synthesis in the solution to old problems due to its high quantum efficiency, especially by obtaining doped nanocrystals and showing photocatalytic properties in the visible region. The long carbon chain acids and amines used at this stage to form a Titanium complex and leads a controlled particle formation. Therefore, nitrogen doping can be carried out in a controlled manner. In this case, the Titanium complex is formed as first action in the synthesis. Additionally, high boiling point solvent (if desired, carboxylic acid or amine, if desired (Trioctyl phosphine or trioctyl phosphine oxide, high boiling point ethers) is mixed with this complex in such a way that the solvent is around 50-70%. Then this mixture, which is placed in the hot injection system, is added in different amounts. It is controlled by another Titanium starting material, amine or acid injection. After the necessary steps, obtained particles are washed and dried. As a result of this process, yellow and orange-like particles are obtained. Optical, thermal, morphological properties are also observed in nanocrystals. While amine-containing structures increase the amount of doping, amines and Titanium complexes provide a medium for the geometrical, dynamic control and the formation of acicular particles.

The structural and characteristic features of the invention and all its advantages will be understood more clearly by the detailed explanation written below, and evaluation should be made by taking these figures and detailed explanation into consideration.

### DETAILED EXPLANATION OF THE INVENTION

In this detailed description, the invention is explained in such a way that the production of TiO2 nanostructures which are photocatalytic active in the visible region and doped with the hot injection method does not have any limiting effect.

Generally, the hot injection method is used to obtain quantum particles, while especially high toxicity containing precursors are used. This means that the obtained quantum particles have very high toxic properties. In the method used in this patent, a green synthesis method is used and no toxic products are obtained.

The long chain carboxylic acids and long chain amines are involved in the modification of the doping amount and surface properties.

One of the methods that can be followed for the control of particle synthesis is the amide structures formed by the reaction of the amine and carboxylic acid salts used as ligands, while the starting salts form a metal oxide crystal structure with each other. Especially long-chain carboxylic acid structures begin to form amide structures, especially after 200° C., with the effect of long-chain amine structures activated during the reaction. The formation of these structures can be studied by FT-IR or NMR spectroscopy. This is also an indicator of particle formation.

During the reaction, no colored complex formation occurs in the initial stages and at relatively low temperatures, while the complex will gradually turn yellow-orange-brown after injection at the determined temperatures, which is actually an evidence of visible region doping. Injection of increasing amounts of amine complex in particular leads the solution towards brownish color. Titanium-containing amine or carboxylic acid complexes lead to the formation of acicular structures.

After doping, a conversion from anatase crystal structure to rutile crystal structure may be observed. This is an example of the change of the crystal structure by the hot injection method for the first time in the literature. Therefore, Titanium (iv) chloride material is mixed with long chain amine structures in different ratios (1:2, 1.4:1:10:1:20) and long chain carboxylic acid structures or even preheated (about 50-60 C with a heat gun)) is injected into the medium.

XPS analyzes identify visible region doping in proportion to the increasing amount of amine. In particular, it was observed that the color of the obtained TiO2 nanostructures shifted towards dark yellow-orange color with increasing doping. As part of the qualitative analysis, these orange colored particles can be obtained with modified groups on their surface.

When the obtained nanostructures were analyzed in a controlled manner by SEM and TEM analysis, it was revealed that the structures could be transformed into an elongated state by injection with the help of carboxylic acid and Titanium-amine complexes. Especially after the pre-treatments, the reaction medium is first covered with a cloudy gas due to the temperature difference and temperature decrease when the injection is performed. Results showed that color change in nanoparticles and geometrical differentiations can be observed by SEM and TEM.

The production method of nitrogen-doped TiO2 nanostructures, which are photocatalytic active in the visible region, by the hot injection method, includes the following process steps:
By using the long chain acids and amines, firstly, Titanium complexes with long chain acids and/or amines whose mole ratios are controlled (1:2:5 or 1:2:10 or 1:2:20 or similar ratios),
By controlling the reaction environment, precursors will be producing nitrogen-doped TiO2 in with controlled geometry, again controlled with long-chain amines,
Mixing firstly prepared Titanium complex with amine and carboxylic acid medium or high boiling point solvents in the range of 250-300° C.,
This mixture then placed in the hot injection system, is controlled by injection of different amounts (from 1 to 20 times) of amine or carboxylic acid or Titanium complexes,
Washing the particles and drying them under 100 C for a few hours.
As a result of this process, yellow and orange colored and doped TiO2 nanoparticles or elongated TiO2 structures are obtained. Similarly, the anatase crystal structure can be converted to the rutile crystal structure as an unusual method of crystal growth habit change

The invention is the production of controlled TiO2 nanoparticles, which may be doped with nitrogen by hot injection method known as first time and can be obtained in an elongated state when necessary and display visible light photocatalytic properties. Especially the Titanium complexes are firstly prepared by modifying the Titanium chloride precursor with long chain acids and again controlled with long chain amines, nitrogen doping is achieved, and in this way, yellow-orange and N doped TiO2 is obtained instead of white TiO2. In the meantime, high boiling point solvents can be used. Since high temperatures are used with the injection method, structures with a very high crystalline structure and photocatalytically active structures which photocatalytic yield is 75% higher compared to Degussa P-25 is obtained.

The present invention primarily produces nitrogen doped and visible light photocatalytic active TiO2 nanoparticles using the hot injection method. Particles are produced at high temperatures (250-300° C.). This method is usually carried out using long-chain acids and amines with controlled mole ratios in high-boiling solvents. The starting materials of the Titanium compound, which are sensitive to air and must be implemented in a protected atmosphere, are required for the initiation of the reaction. A nitrogen or argon atmosphere can be used for the reaction atmosphere. Thus, TiO2 particles are obtained by molecular control and they are ensured to be active in the visible light region.

The synthesis method of shape controlled (spherical or acicular) and nitrogen-doped TiO2 nanostructures is described. These nanoparticles are mostly in the anatase crystal structure but injections may transform them into another crystal structure. The particles show high visible photocatalytic activity and are the first nitrogen-doped TiO2 nanoparticles by hot injection method.

It is clear that a person skilled in the art can demonstrate the innovation set forth in the invention by using similar methods and/or can apply this method to other similar purposes used in the related art. Therefore, it is obvious that such methods will lack the criteria of novelty and in particular of overcoming the state of the art.

1-10. (canceled)

11. A production method, comprising: producing nitrogen-doped TiO2 nanostructures using a hot injection method which is photocatalytic active in the visible region as evidenced by XPS, UV-Vis and EDX analysis.

12. The method of claim 11, wherein hot injection is conducted by the use of long-chain acids and amines, which are initiated by modifying titanium complexes with long-chain amine or acids and whose mole ratios are controlled.

13. The method of claim 11, wherein the hot injection mixture, which is then placed in the hot injection system, is controlled with different amounts of Titanium complex initiator, amine or acid injection modulated the the desired system.

14. The method of claim 11, wherein nitrogen-doped TiO2 in controlled geometry by modulating with long-chain amines and Titanium complexes is fabricated.

15. The method of claim 11, wherein when the ratio of amine and Titanium initiator is varied and multiple injections are made, both nitrogen-doped and acicular TiO2 nanoparticles can be obtained.

16. The method of claim 11, further comprising mixing high boiling point solvents in the range of 250-300° C. with this complex.

17. The method of claim 11, further comprising, after desired hot injection system in Schlenk line under nitrogen atmosphere, washing, with low carbon content alcohols, and drying the particles at 100 C.

18. The method of claim 11, further comprising producing and examining dark yellow TiO2 nanoparticles as a result of this process.

19. The method of claim 11, wherein in the hot injection method, for the production of nitrogen doped TiO2 nanostructures where has the visible range photocatalytic activity feature, wherein the nanostructures have high crystallinity.

20. The method of claim 11, wherein in the hot injection method, for the production of nitrogen doped TiO2 nanostructures where the nanostructure crystal habits is changed by the designed hot injection.
